(19) United States
(12) Patent Application Publication
(10) Pub. No.: US 2013/0009018 A1
(43) Pub. Date: Jan. 10, 2013

(54) METHOD OF CABLE FABRICATION

(76) Inventors: John Palahnuk, Valencia, CA (US); Howard Lind, Porter Ranch, CA (US)

(21) Appl. No.: 13/179,546

(22) Filed: Jul. 10, 2011

(51) Int. Cl. F16L 3/08; B32B 38/14; B32B 37/16

(52) U.S. Cl. 248/49; 156/278; 156/390

(57) ABSTRACT

The embodiments disclose a method of cable fabrication, achieved by encasing a flat piece of steel in silicone to form a flexrail, attaching two or more flexrails to a cable in a secondary bonding operation to create a flexible self-supporting cable and encasing two or more flat pieces of steel and one or more flat cable elements in a continuous automated encasement bonding operation to create a flexible self-supporting cable of any length.

### BACKGROUND

The support of cables spanning any distance is generally accomplished with the use of brackets, cable carriers or other support mechanisms. The cable support mechanisms or mechanical joints may include moving parts. Support mechanisms with cables inside attached to the moving parts of a machine for example may need additional support to avoid conflicting with the movement of the machine moving parts. Mechanical joints in a cable carrier may bind and damage the cables or cause damage to the machine parts.

### BRIEF DESCRIPTION OF THE DRAWINGS

FIG. 1 shows a block diagram of an overview of a method of cable fabrication of one embodiment.

FIG. 2A shows a block diagram of an overview flow chart of a method of cable fabrication secondary bonding operation of one embodiment.

FIG. 2B shows a block diagram of an overview flow chart of a method of cable fabrication automated cable fabrication of one embodiment.

FIG. 3A shows for illustrative purposes only an example of flexrail flat piece of steel of one embodiment.

FIG. 3B shows for illustrative purposes only an example of the silicone encasement of a flexrail flat piece of steel of one embodiment.

FIG. 3C shows for illustrative purposes only an example of a cable of one embodiment.

FIG. 3D shows for illustrative purposes only an example of two flexrails bonded to a cable of one embodiment.

FIG. 3E shows for illustrative purposes only an example of a flexrail self supporting cable structure in a flexed bending position of one embodiment.

FIG. 4A shows for illustrative purposes only an example of a flexrail dimension adjustment bonded to a narrow width conductor cable flexrail self supporting cable structure of one embodiment.

FIG. 4B shows for illustrative purposes only an example of a flexrail dimension adjustment bonded to a wide conductor and communication cable flexrail self supporting cable structure of one embodiment.

FIG. 4C shows for illustrative purposes only an example of a flexrail dimension adjustment bonded to a wide fluid and gas tubing cable flexrail self supporting cable structure of one embodiment.

FIG. 4D shows for illustrative purposes only an example of a flexrail dimension adjustment bonded to a wide multiple purpose cable flexrail self supporting cable structure of one embodiment.

FIG. 4E shows for illustrative purposes only an example of nesting flexrail cables of one embodiment.

FIG. 5 shows for illustrative purposes only an example of a flexrail self supporting cable structure flexing at the bend point of one embodiment.

FIG. 6A shows for illustrative purposes only an example of exposed conductor cables and flexrail bending of one embodiment.

FIG. 6B shows for illustrative purposes only an example of flexible bending and rigid parallel positions of an encased and bonded flexrail self supporting cable structure of one embodiment.

FIG. 7A shows for illustrative purposes only an example of a flexrail self supporting cable attached to the moving parts of a machine of one embodiment.

FIG. 7B shows for illustrative purposes only an example of intermediate travel of a flexrail self supporting cable attached to the moving parts of a machine of one embodiment.

FIG. 7C shows for illustrative purposes only an example of extended travel of a flexrail self supporting cable attached to the moving parts of a machine of one embodiment.

FIG. 8 shows for illustrative purposes only an example of an automated cable fabrication process of one embodiment.

FIG. 9 shows for illustrative purposes only an example of extended travel of a flexrail self supporting cable attached to the vertical moving parts of a machine of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a method of cable fabrication is described for illustrative purposes and the underlying system can apply to any number and multiple types of flexible self supporting cable structures. In one embodiment the method of cable fabrication can be configured using one or more metals to form the flat piece of steel to include silicone encasement to create a flexrail. In one embodiment the flat piece of steel may include non-metallic materials such as one or more types of plastic to create a flexrail. The method of cable fabrication can be configured to include encasement materials for example silicone, PVC, polyurethane, Teflon and natural rubber. In one embodiment the method of cable fabrication can be configured to include two or more flexrails as an add-on feature to any cable using a secondary bonding operation. In one embodiment the method of cable fabrication can be configured to include an automated process using an apparatus to encase two or more flexrails and cable elements such as one or more conductors, communication and signal cables, fiber optic cables, fluid and gas tubing to create flexible self supporting cable structures in continuous lengths using the present invention.

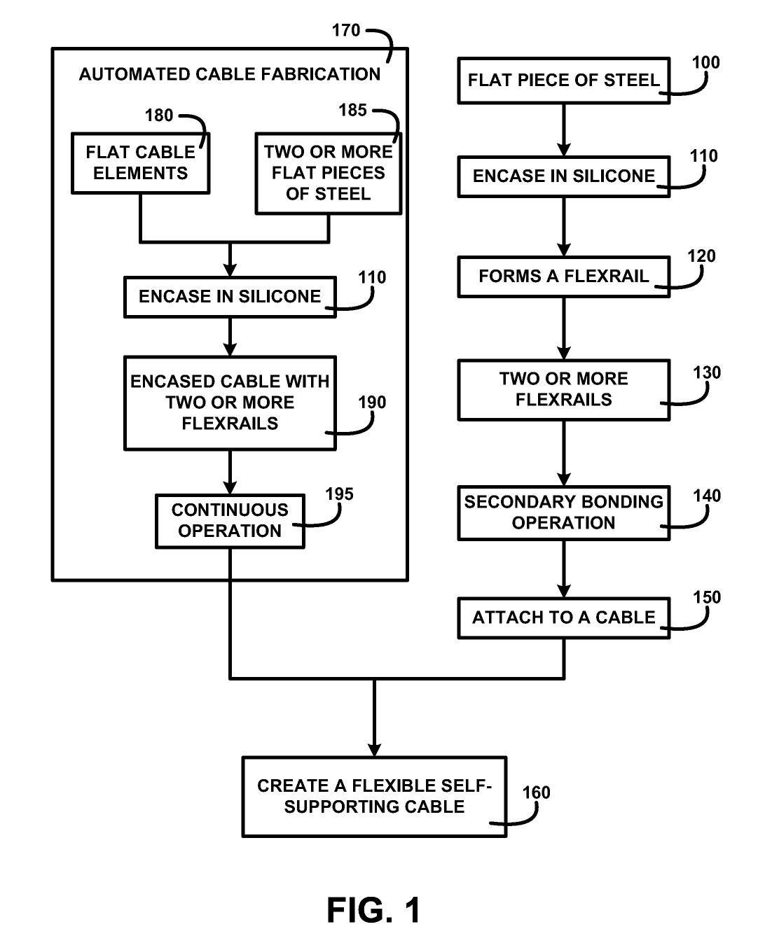

FIG. 1 shows a block diagram of an overview of a method of cable fabrication of one embodiment. In one embodiment the method of cable fabrication may include a flat piece of steel 100. The next step in the cable fabrication includes an apparatus to continuously encase in silicone 110 the flat piece of steel 100. The silicone encased flat piece of steel 100 forms a flexrail 120. The silicone encasement process may be configured to create one or more length of the flexrail 120.

The cable fabrication may include a step wherein two or more flexrails 130 attach to a cable 150 using a secondary bonding operation 140. A cable 150 may be configured to include one or more width and thickness dimension and one or more shape. A cable 150 may be configured to include one or more of multiple types of elements for example conductors, communication cables and tubing.

The bonding of two or more flexrails 130 to attach to a cable 150 is configured to create a flexible self-supporting cable 160. The flexible self-supporting cable 160 is configured to span a distance and be counter levered without brackets, cable carriers or support mechanisms. The flexible self-supporting cable 160 is configured to utilize mechanical properties of the flexrails in an isomorphic manner, flexing at a bending point and rigid where unsupported. The sections of the flexible self-supporting cable 160 before and after bending are configured to maintain a parallel position to one another.

The flexible self-supporting cable 160 may be configured to include two braces configured to be attached to the flexrail flexible self-supporting cable to hold down the two ends, one on a fixed end and the other on a moving end such as a moving part of a machine. The flat piece of steel 100 may be configured to include adjustments of the width and thickness dimensions for applications including multiple types, widths, thicknesses and types of cable. The unsupported distances of a span of flexible self-supporting cable 160 may be configured to be increased or decreased using adjustments of the width and thickness dimensions of the flat piece of steel 100.

The secondary bonding operation 140 may be configured to adjust the application of a bonding material to form a flexible self-supporting cable 160 using multiple types, widths, thicknesses and types of cable. The flexrail flexible self-supporting cable 160 may reduce the cost of additional materials used to support spans of cables. The method of cable fabrication provides an adaptable means to fabricate flexible self-supporting cables using flexrails as an add-on feature to any cable of one embodiment.

In one embodiment the method of cable fabrication may include an automated cable fabrication 170 process. The automated cable fabrication 170 process may be configured to include the assembly of flat cable elements 180 and two or more flat pieces of steel 185 in a continuous operation. The flat cable elements 180 and two or more flat pieces of steel 185 may be configured to be fed into an apparatus to position the cable elements and flat pieces of steel into a predetermined orientation. The apparatus may include a process to encase in silicone 110 the positioned cable elements and flat pieces of steel to form an encased cable with two or more flexrails 190. The automated cable fabrication 170 process may include cable elements and flat pieces of steel on sources such as reels to supply a continuous operation 195. The automated cable fabrication 170 process may create a flexible self-supporting cable 160 of any length of one embodiment.

### Detailed Description:

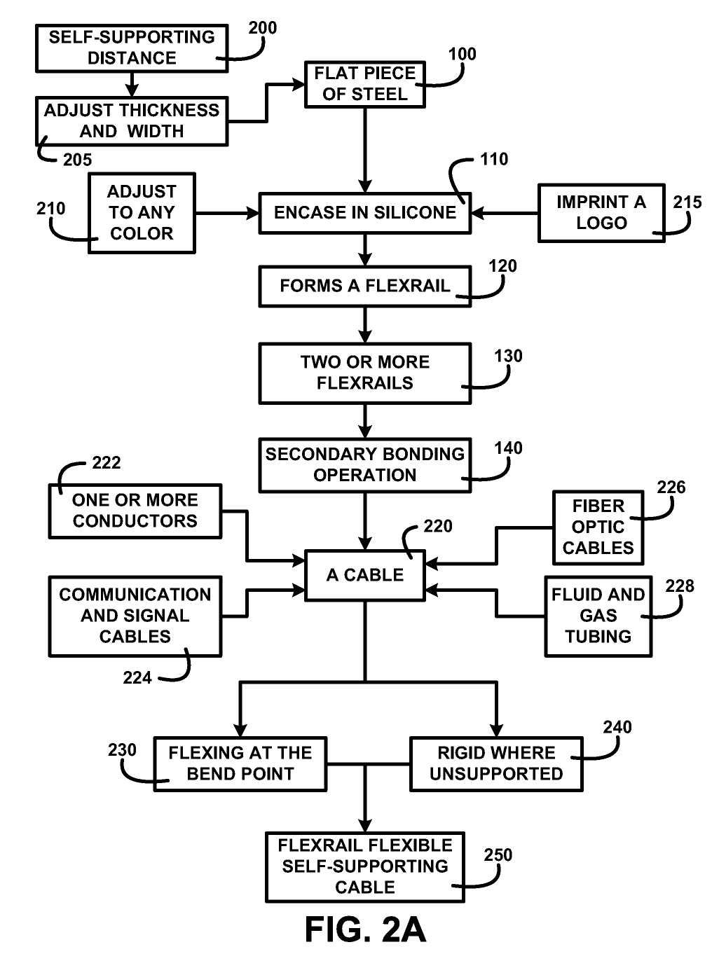

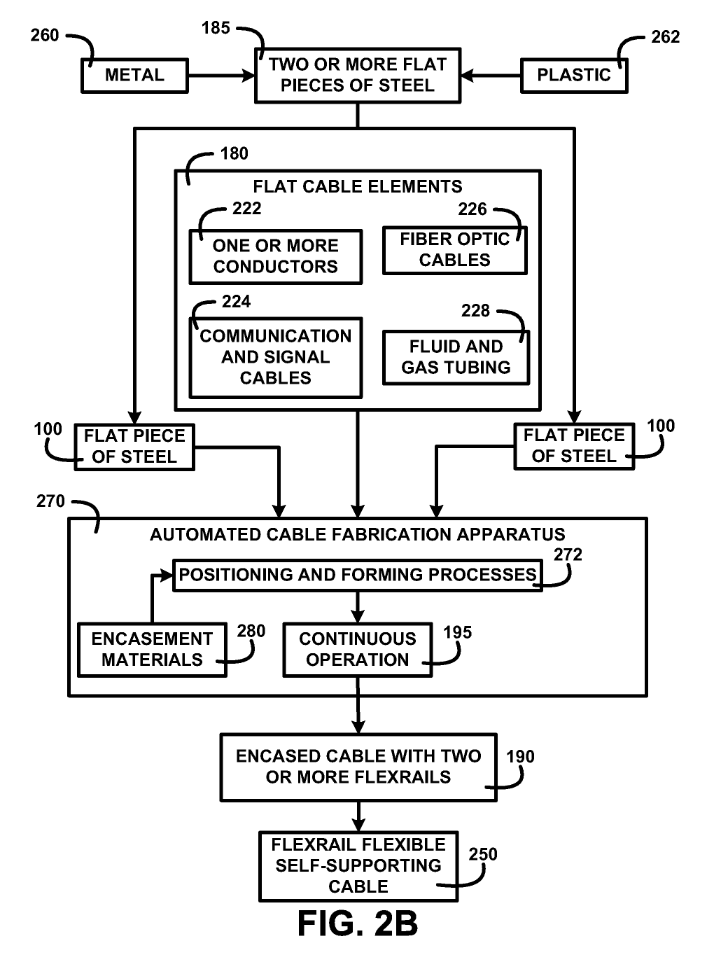

FIG. 2A shows a block diagram of an overview flow chart of a method of cable fabrication secondary bonding operation of one embodiment. FIG. 2A shows the method of cable fabrication that includes the use of a flat piece of steel 100. The cable fabrication is configured to use an apparatus to encase in silicone 110 the flat piece of steel 100 to create a flexrail 120. The flat piece of steel 100 and silicone encasement is configured to adjust thickness and width 205 of both the flat piece of steel 100 and silicone encasement for use as an add-on feature to multiple sizes, shapes and types of cable. The thickness and width adjustments are configured to adjust the self-supporting distance 200 of a flexrail flexible self-supporting cable 250. The silicone encasement is configured to adjust to any color 210. The silicone encasement is configured to imprint a logo 215 onto the outboard side of the flexrail silicone encasement of one embodiment.

The secondary bonding operation 140 is configured to use an apparatus to attach to a cable 150 of FIG. 1 two or more flexrails 130 to create the flexrail flexible self-supporting cable 250. The secondary bonding operation 140 is configured to include a cable 220 that may include one or more conductors 222, communication and signal cables 224, fiber optic cables 226, fluid and gas tubing 228. The cable may be of any type, width and thickness dimension of one embodiment.

The flexrail flexible self-supporting cable 250 utilizes two mechanical properties of the flexrails in an isomorphic manner, flexing at the bend point 230 and rigid where unsupported 280. The flexing at the bend point 230 includes each flexrail flexing in an outward direction at the curved entrance to the bend. A maximum flexed position results in the full bending position. The flexrail flexing reverses to an inward direction as the flexrail flexible self-supporting cable 250 returns to a straight path. Before and after the bending the flexrail flexible self-supporting cable 250 maintains a structure that is rigid where unsupported 240. The self-supporting rigid configuration may include the spanning of a distance without the use of brackets, cable carriers or support mechanisms of one embodiment.

The flexrail flexible self-supporting cable 250 is configured to include a brace to attach to a fixed end attachment of for example a machine wherein the attachment may include a power source circuit connection for conductors in a cable 220. The flexrail flexible self-supporting cable 250 is configured to include a brace to attach to a moving end attachment to for example a moving part of a machine. The flexrail flexible self-supporting cable 250 is configured to form a dynamic bend that transitions as the flexrail flexible self-supporting cable 250 extends and retracts with the movement of the moving part. The flexrail flexible self-supporting cable 250 is configured to form a static bend in non-moving applications and when a moving part is in a non-moving mode. The parallelism of the two rigid unsupported before and after a bend is maintained in both a static and dynamic movement. The method of cable fabrication produces the flexrail flexible self-supporting cable 250 which eliminates the use of additional materials to support spans of cables of one embodiment.

FIG. 2B shows a block diagram of an overview flow chart of a method of cable fabrication automated cable fabrication of one embodiment. FIG. 2B shows the automated cable fabrication 170 of FIG. 1 process that is configured to feed into an automated cable fabrication apparatus 270 two or more flat pieces of steel 185. The two or more flat pieces of steel 185 may be configured to use materials such as one or more type of metal 260. The two or more flat pieces of steel 185 may be configured to use non-metallic materials such as one or more types of plastic 262 to create a flexrail.

The flat cable elements 180 may also be configured to feed into the automated cable fabrication apparatus 270. The flat cable elements 180 fed into the apparatus may include one or more conductors 222, communication and signal cables 224, fiber optic cables 226, fluid and gas tubing 228. The cable elements and two or more flat pieces of steel 185 may be supplied on one of more separate supply sources such as two sources each supplying one flat piece of steel 100 to both sides of an assembly of cable elements and flat pieces of steel.

The automated cable fabrication apparatus 270 may be configured to include a positioning and forming processes 272. Positioning processes are configured to place and hold into a predetermined position each of the cable elements and flat pieces of steel. Forming processes may include the injection of encasement materials 280 into a molding form wherein the cable elements and flat pieces of steel are held in position. The encasement materials 280 may include for example silicone, PVC, polyurethane, Teflon and natural rubber. The encasement materials 280 flow around each of the cable elements and flat pieces of steel in the shape of the molding form. The cable elements and flat pieces of steel may be drawn though the molding forms, as encasement materials are injected, in a continuous operation 195. The forming processes may be configured to include curing processes to set the shape of the encasement. The continuous operation 195 produces the encased cable with two or more flexrails 190. The automated cable fabrication 170 of FIG. 1 continuous operation 195 can be configured to create the flexrail flexible self-supporting cable 250 of any length of one embodiment.

### Flexrail Flexible Self-Supporting Cable Structure:

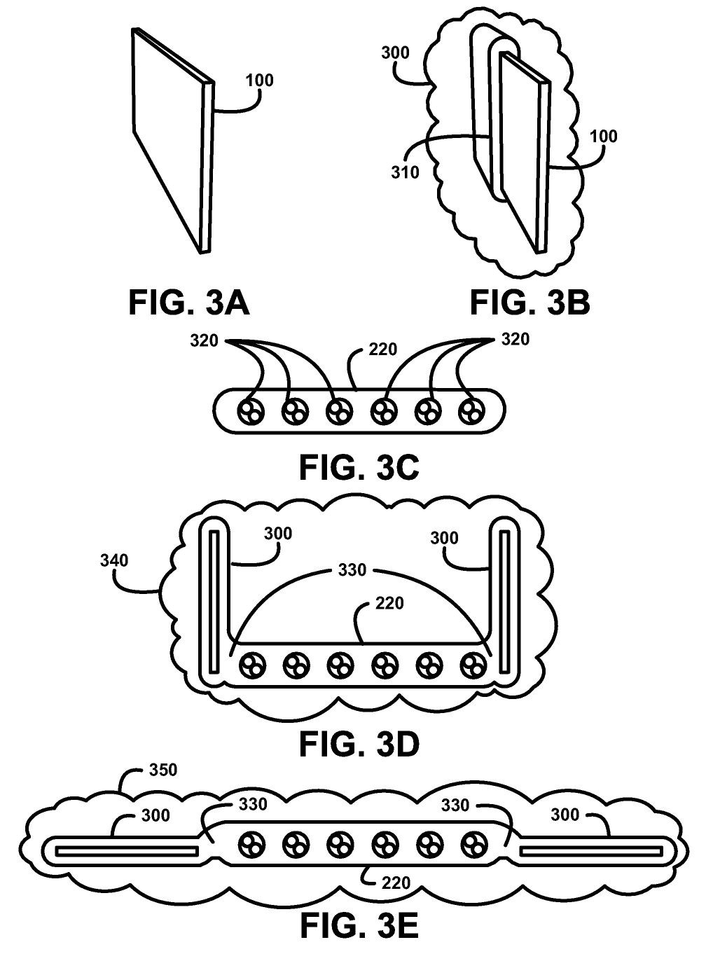

FIG. 3A, 3B, 3C, 3D and 3E illustrate the component parts and cable fabrication of the flexrail flexible self-supporting cable structure of one embodiment. FIG. 3A shows for illustrative purposes only an example of flexrail flat piece of steel of one embodiment. The flat piece of steel 100 is configured to be used in a continuous process to fabricate a flexrail component. Adjustments of the thickness and width dimensions of the flat piece of steel 100 are configured to control the self-supporting distances of the flexrail flexible self-supporting cables of one embodiment.

### Flexrail Silicone Encasement:

FIG. 3B shows for illustrative purposes only an example of the silicone encasement of a flexrail flat piece of steel of one embodiment. The flat piece of steel 100 is encased in silicone in a continuous fabrication process. The flat piece of steel 100 is fed into an apparatus as a means of applying the silicone encasement 310 in a continuous process. The continuous process is configured to produce varying lengths of the silicone encased flat piece of steel 100 to form a flexrail 300. The flexrail 300 silicone encasement 310 is configured to be any color including clear, white and black. The apparatus used to apply the silicone encasement 310 is configured to include imprinting a logo onto the outboard side of the flexrail silicone encasement of one embodiment.

### Cable:

FIG. 3C shows for illustrative purposes only an example of a cable of one embodiment. FIG. 3C shows a cable 240 that includes for example cable conductor elements 320. The cable 240 may include shapes that are flat, thicker, narrow and wide. The cable 240 may include varying lengths. The thickness of the cable 240 may for example include a thickness of at least 0.125 inch. The cable 240 may be configured to include for example one or more insulated and non-insulated conductors, communication and signal cables, fiber optic cables, fluid and gas tubing of one embodiment.

### Secondary Bonding Operation:

FIG. 3D shows for illustrative purposes only an example of two flexrails bonded to a cable of one embodiment. The cable fabrication process may include an apparatus used in a secondary bonding operation as a means of attaching two or more flexrail 300 components to the cable 240. A bonding connection 330 joining the flexrail 300 components to the cable 240 may be configured to be adjustable in thickness and placement. The bonding connection 330 holds the flexrail 300 components in a rigid position 340 configured to create a self supporting structure for an unsupported span of the flexrail cable. The flexrail flexible self-supporting cable structure is configured to utilize two mechanical properties of the flexrails in an isomorphic manner, flexing at the bend point and rigid where unsupported of one embodiment.

### Flexed Bending Position:

FIG. 3E shows for illustrative purposes only an example of a flexrail self supporting cable structure in a flexed bending position of one embodiment. The bonding connection 330 joining the flexrail 300 and cable 240 is configured to be a flexible joint. Each flexrail 300 in a self supported cable span is configured to outwardly flex from the rigid position using the bonding connection 330 flexible joint. The outward flexing occurs as the self supported cable span begins to curve into a bending position. The outward flexing of each flexrail is maximized as illustrated in the flexed bending position 350 of the flexrail flexible self-supporting cable. Each flexrail 300 begins to inwardly flex back to the rigid position as it straightens out of the bend. Returning to the rigid position the flexrail flexible self-supporting cable is parallel to the self supported cable span leading into the bending point. The flexrail flexible self-supporting cable structure is configured to be counter levered without brackets, cable carriers or support mechanisms of one embodiment.

### Flexrail Dimension Adjustment:

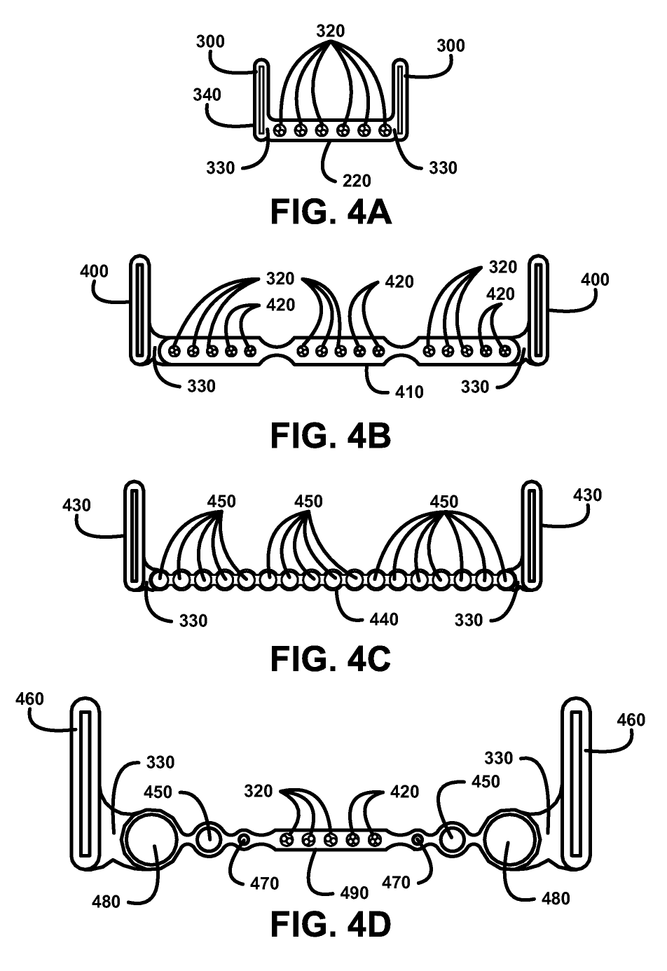

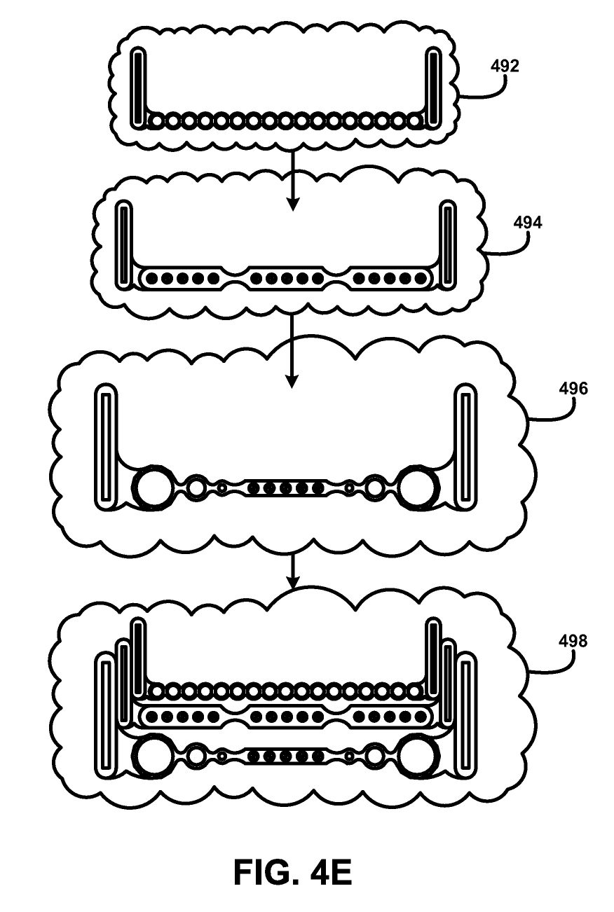

FIG. 4A, 4B, 4C and 4D show examples of adjustments in the dimensions of a silicone encased flexrail component and bonding connections to different cable types as an add-on feature. The width of the cable and bonded flexrails is configured to be controlled by adjusting the thickness dimension of the flat piece of steel and the thickness dimension of the cable of one embodiment.

FIG. 4A shows for illustrative purposes only an example of a flexrail dimension adjustment bonded to a narrow width conductor cable flexrail self supporting cable structure of one embodiment.

FIG. 4A shows a narrow cable 240 configured to include cable conductor elements 320. Two encased flexrail 340 components have been joined to the narrow cable 240 using the bonding connection 330 process to form the narrow cable adjusted flexrail 300 of one embodiment.

FIG. 4B shows for illustrative purposes only an example of a flexrail dimension adjustment bonded to a wide conductor and communication cable flexrail self supporting cable structure of one embodiment. FIG. 4B shows a wide thick cable 410 configured to include cable conductor elements 320 and cable communication and signal elements 420. The wide thick cable 410 is shown with a thick cable adjusted flexrail 400 joined at either side using the bonding connection 330 of one embodiment.

FIG. 4C shows for illustrative purposes only an example of a flexrail dimension adjustment bonded to a wide fluid and gas tubing cable flexrail self supporting cable structure of one embodiment. FIG. 4C shows a wide flat cable 440 configured to include cable fluid and gas tubing elements 450. The bonding connection 330 process has joined a thin cable adjusted flexrail 430 at both sides of the wide flat cable 440 of one embodiment.

FIG. 4D shows for illustrative purposes only an example of a flexrail dimension adjustment bonded to a wide multiple purpose cable flexrail self supporting cable structure of one embodiment. Different cable types may include a wide multiple purpose cable 490. The wide multiple purpose cable 490 may include cable conductor elements 320, cable communication and signal elements 420, cable fluid and gas tubing elements 450, cable fiber optic cable elements 470 and cable compressed air tubing elements 480. A wide multiple purpose cable adjusted flexrail 460 is shown joined to the wide multiple purpose cable 490 using the bonding connection 330 process. The adjustments in the thickness dimension of the flat piece of steel and the thickness dimension of the cable has controlled the width of the cable and bonded flexrails. The adjustments in the width and thickness dimensions of the flat piece of steel have additionally controlled the self-supporting distances of each example of the flexrail cables of one embodiment.

### Nesting Flexrail Cables:

FIG. 4E shows for illustrative purposes only an example of nesting flexrail cables of one embodiment. The flexrail flexible self-supporting structure may be configured to include the nesting or grouping of one or more flexrail cables inside of another flexrail cable. Adjustments in the dimensions of flexrails and bonding connections may be configured to control the overall width of a flexrail cable to physically fit inside a wider flexrail cable. FIG. 4E shows an example of a fluid and gas tubing flexrail cable 492 configured to an overall width dimension to fit inside a wider conductor flexrail cable 494.

The conductor flexrail cable 494 is configured to an overall width dimension to fit inside a wider multiple purpose flexrail cable 496. The three grouped flexrail cables form nested flexrail cables 498 that may be configured to span a distance together unsupported by other means. For example the three separate flexrail cables may to nested in a group above one side of a factory area, cross over the area as a self-supporting group and be separated again on the other side. The higher layered cable density of the nested flexrail cables 498 may reduce the number of crossings and additional cost of multiple supported cable spans of one embodiment.

### Flexrail Bending:

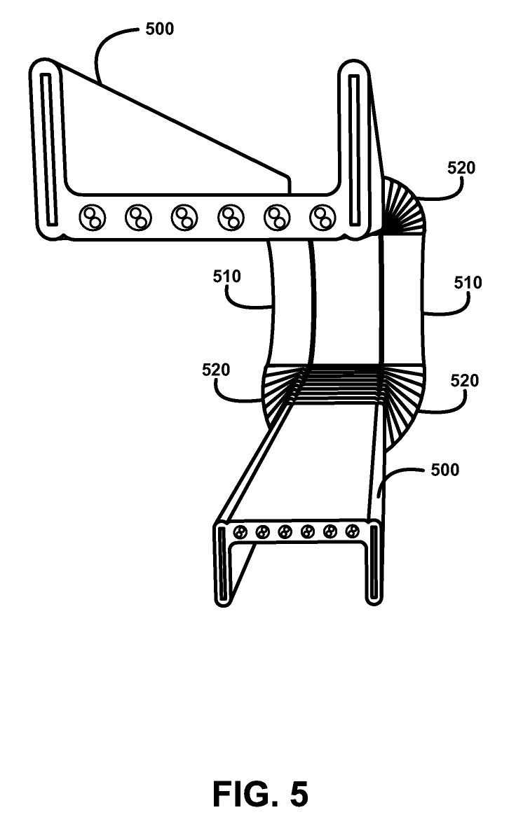

FIG. 5 shows for illustrative purposes only an example of a flexrail self supporting cable structure flexing at the bend point of one embodiment. The structure formed by joining two flexrail 300 of FIG. 3B components to a cable 240 of FIG. 2 using the bonding connection 330 of FIG. 3D process develops mechanical properties. The mechanical properties of the structure may include flexing at the bend point and rigid where unsupported of one embodiment.

FIG. 5 shows a flexrail rigid unsupported section 500 and a flexrail bending point flexing section 520. The flexrail rigid unsupported section 500 may be spanned over a distance or be counter levered without brackets, cable carriers or support mechanisms. When the path of the flexrail rigid unsupported section 500 start a curved change of direction to begin bending the flexrails in the structure flex outwardly as shown in the flexrail bending point flexing section 520. The flexing reaches the maximum in a bending point section 510. The bending point section 510 shows each flexrail 300 of FIG. 3B flexed outwardly as the bending continues. When the bending path starts to return to a straight path the maximum flexing of each flexrail 300 of FIG. 3B component starts to reduce and flexes inwardly. The inward flexing is completed when the straight path is reached. The structure returns to the rigid unsupported section 500 position of one embodiment.

### Flexrail Cable Element Bending:

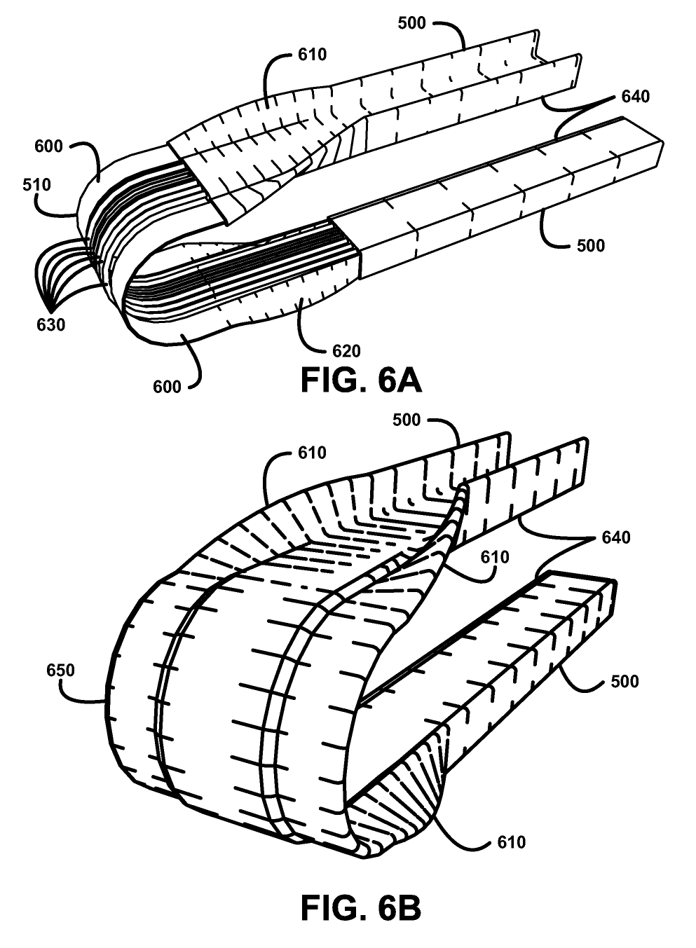

FIG. 6A shows for illustrative purposes only an example of exposed conductor cables and flexrail bending of one embodiment. FIG. 6A shows the rigid unsupported section 500 and maximum flexed position at the bending point section 510. Portions of the silicone encasement 310 of FIG. 3B of each flexrail 300 of FIG. 3B and the outer coating of the cable 240 of FIG. 2 are not shown to illustrate the flexing and bending of the exposed encased and coated elements. The encased flexrail flexing section 610 shows the flexing at one end of the bending movement. A view of the exposed flat piece of steel bending 600 is shown in the maximum flexed position. A view of flat piece of steel flexing 620 is shown exposed as it transitions from and to the rigid position.

Also shown in FIG. 6A are cable elements bending 630 during the bending movement. The flexing of the flexrails and bending of the cable elements are configured to occur in a static bend or dynamic bending movement. Rigid unsupported section parallel positioning 640 of the flexrail cable occurs in both the rigid unsupported section 500 leading into a bend and the rigid unsupported section 500 after the bend of one embodiment.

### Flexrail Cable Rigid Parallelism:

FIG. 6B shows for illustrative purposes only an example of flexible bending and rigid parallel positions of an encased and bonded flexrail self supporting cable structure of one embodiment. FIG. 6B shows a flexrail self supporting cable bending 650 from the rigid unsupported section 500. The flexrail flexing section 610 flexes outwardly to reach the maximum flexed position at the bending point. The inward flexing of the flexrail flexing section 610 returns the flexrail self supporting cable bending 650 to the rigid unsupported section 500 position. The rigid unsupported section parallel positioning 640 for example of both sections of the rigid unsupported flexrail cable is maintained in a static bend. A dynamic bending movement wherein one end of the flex cable is fixed using a fixed brace attachment and the other end is attached to a brace of a moving part is configured to maintain the rigid unsupported section parallel positioning 640 of one embodiment.

### Flexrail Self Supporting Cable Movement:

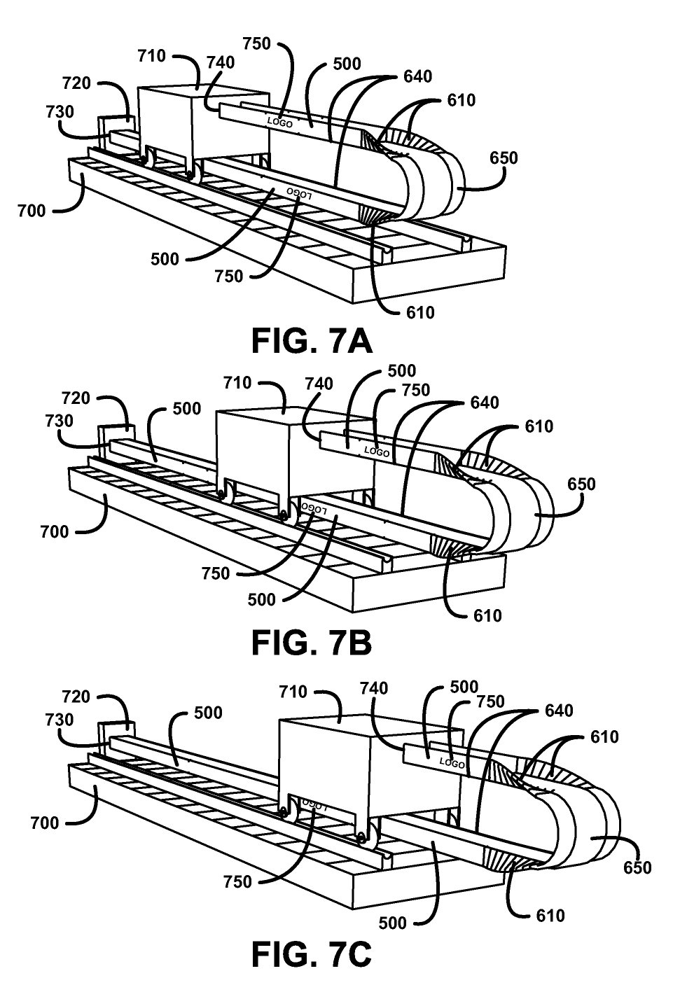

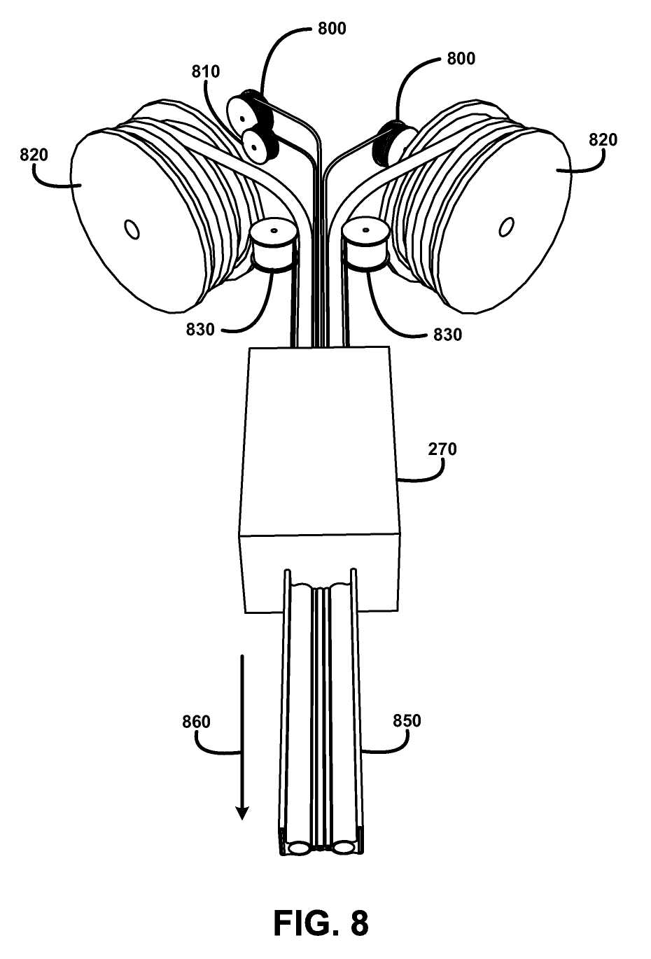

The flexrail self supporting cable structure may be configured to attach to the moving parts of a machine. FIG. 7A, 7B and 7C illustrate the fixed and movable attachments to a moving part of a machine and the extendibility of the flexrail self supporting cable structure parallel self support as the moving part travels along a track. FIG. 7A shows for illustrative purposes only an example of a flexrail self supporting cable attached to the moving parts of a machine of one embodiment. FIG. 7A shows for example a machine track system 700 and a moving part 710 that travels on the track. A fixed control and power connection 720 at one end may supply the power and moving part control connections to operate the moving part 710 of the machine. One end of the rigid unsupported section 500 of a flexrail cable is attached to the fixed control and power connection 720 using a brace to create a fixed end attachment 730. The other end of a flexrail cable using a brace is attached to the moving part 710 to create a moving end attachment 740. FIG. 7A shows an imprinted logo 750 on the flexrail cable. The imprinted logo 750 may be configured to include a company name, a safety warning and a part number of one embodiment.

FIG. 7A for example may show the moving part 710 where it has stopped traveling along the track. In this instance the flexrail cable from the fixed end attachment 730 begins with a rigid unsupported section 500. The rigid unsupported section 500 transitions into a flexrail flexing section 610 as it enters the bend. The outward flexing of the flexrails increases until it reaches the maximum flexed position in the flexrail flexed bend section 650. Inward flexing begins to transition the flexrail flexed bend section 650 to the flexrail flexing section 610 that completes a static bending to the rigid unsupported section 500 connected to the moving end attachment 740. A static bend may occur as the moving part 710 cycles through the machine operation of one embodiment.

### Intermediate Travel Movement:

FIG. 7B shows for illustrative purposes only an example of intermediate travel of a flexrail self supporting cable attached to the moving parts of a machine of one embodiment. FIG. 7B shows an example of the moving part 710 traveling along the machine track system 700 toward the end of the track. In this example the intermediate travel of the moving part 710 creates a dynamic bending movement in the flexrail self supporting cable attached to the moving part 710. The flexrail self supporting cable is attached to the control and power connection 720 using the fixed end attachment 730. The fixed end of the rigid unsupported section 500 is elevated above the surface of the machine track system 700 of one embodiment.

The travel of the moving part 710 may cause the dynamic transitioning of the outward flexing of the flexrail flexing section 610, the flexrail flexed bend section 650 and inward flexing of the flexrail flexing section 610 to the rigid unsupported section 500 leading to the moving end attachment 740. The flexible bonding connection 330 of FIG. 3D is configured to maintain flexibility during continuous dynamic flexing of the encased flexrails of one embodiment.

The rigid unsupported section parallel positioning 640 is configured to be maintained through dynamic bending movement. The elevated position of the fixed end of the rigid unsupported section 500 above the surface of the machine track system 700 prevents damage to the flexrail self supporting cable such as contact with metal shavings, hydraulic fluids and being pinched by moving parts of a machine. The imprinted logo 750 may be configured to include operating descriptions of the cable elements and circuits of one embodiment.

### Extended Travel Movement:

FIG. 7C shows for illustrative purposes only an example of extended travel of a flexrail self supporting cable attached to the moving parts of a machine of one embodiment. The rigid unsupported section parallel positioning 640 is configured to be maintained through the extended travel of the moving part 710 to the end of the machine track system 700. The flexrail cable is extended past the end of the machine track system 700 including the flexrail flexed bend section 650 and both top and bottom flexrail flexing section 610. The top rigid unsupported section 500 using the moving end attachment 740 to the moving part 710 maintains the parallel position to the lower rigid unsupported section 500 of one embodiment.

The fixed rigid unsupported flexrail cable maintains the elevated position above the surface of the machine track system 700. The imprinted logo 750 may be configured to include a cautionary warning of the extended flexrail cable. The color of the silicone encasement 310 of FIG. 3B may be configured to include a cautionary color such as yellow or red to more easily visualize the extension of the flexrail cable beyond the end of the machine track system 700 of one embodiment.

### Automated Cable Fabrication:

FIG. 8 shows for illustrative purposes only an example of an automated cable fabrication process of one embodiment. FIG. 8 shows the feeding of both flat cable elements 180 of FIG. 1 and two or more flat pieces of steel 185 of FIG. 1 into the automated cable fabrication apparatus 270. The sources of the flat cable elements 180 of FIG. 1 may be configured to include a conductor cable element on a reel 800, a fiber optic cable element on a reel 810 and a tubing cable element on a reel 820. The two or more flat pieces of steel 185 of FIG. 1 may be configured to include separate sources of a flat piece of steel on a reel 830.

The flat cable elements 180 of FIG. 1 and two or more flat pieces of steel 185 of FIG. 1 are positioned into a predetermined orientation as they enter the automated cable fabrication apparatus 270. The positioned elements and flat pieces of steel may be configured to enter an encasement molding form. Encasement materials 280 of FIG. 2B may be configured to be injected into the encasement molding form as the positioned elements and flat pieces of steel are drawn through the form. The automated cable fabrication apparatus 270 may be configured to include a curing process to set the shape of the encasement materials 280 of FIG. 2B. The feeding of both flat cable elements 180 of FIG. 1 and two or more flat pieces of steel 185 of FIG. 1, positioning and encasement processes are configured for a continuous operation of automated cable fabrication 860. The automated cable fabrication process produces continuous automatically encased cable with two or more flexrails 850 of one embodiment.

### Flexrail Self Supporting Cable Vertical Movement:

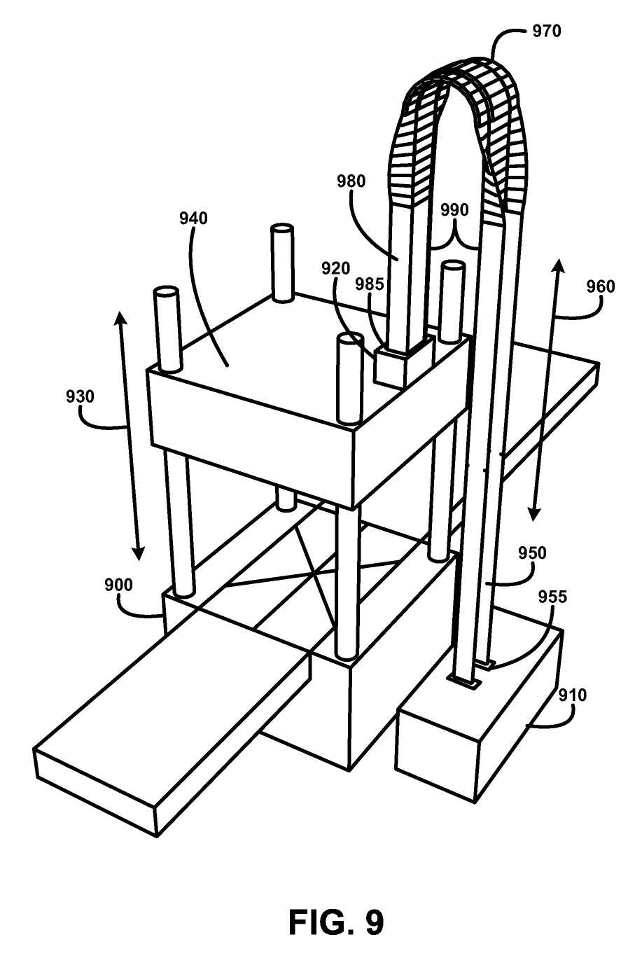

FIG. 9 shows for illustrative purposes only an example of extended travel of a flexrail self supporting cable attached to the vertical moving parts of a machine of one embodiment. The flexrail self supporting cable structure may be configured to attach to the vertical moving parts 940 of a machine. FIG. 9 illustrates the fixed and movable attachments to a vertically moving parts 940 of a vertically oriented machine 900 and the extendibility of the flexrail self supporting cable structure during the moving parts vertical travel 930 along guide posts of one embodiment.

The flexrail self supporting cable structure may be configured to attach one end of the cable to a fixed connection 910 using a vertical fixed connection brace 955. The other end may be configured to attach to a vertically moving part connection 920 using a vertical moving connection brace 985. The vertical fixed connection brace 955 maintains a fixed end rigid unsupported vertical section 950 during the moving parts vertical travel 930. The vertical moving connection brace 985 attachment to the vertically moving part connection 920 maintains a moving end rigid unsupported vertical section 980 of one embodiment.

Flexrail self supporting vertical cable movement 960 is configured to flex the cable going into the bending point to configure the cable into a vertical bending point section 970. The maximum flexed position is reached at the bending point and begins to relax the flexed position as the cable exits the bending radius. The flexible bending of the cable is configured to occur in both directions of the flexrail self supporting vertical cable movement 960. A parallel self supporting 990 relationship of the two rigid self supporting cable sections is maintained during either direction of the flexrail self supporting vertical cable movement 960 of one embodiment.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method of cable fabrication, comprising:
encasing a flat piece of steel in silicone to form a flexrail;
attaching two or more flexrails to a cable in a secondary bonding operation to create a flexible self-supporting cable; and
encasing two or more flat pieces of steel and one or more flat cable element in a continuous automated encasement bonding operation to create a flexible self-supporting cable.

2. The method of claim 1, wherein the flexrail flexible self-supporting cable is configured to be support spans in a range of horizontal to vertical orientations without the use of brackets, cable carriers or support mechanisms.

3. The method of claim 1, wherein the flexrail cable utilizes two mechanical properties of the flexrails in an isomorphic manner, flexing at the bend point and rigid where unbent and unsupported.

4. The method of claim 1, further comprising two or more attachment braces configured to make a connection of the cable at two or more ends including fixed and moving connections.

5. The method of claim 1, wherein the flexrail is configured to be bonded to any cable and applied as an add-on feature and includes an automated cable fabrication process wherein flexrails and cable elements are bonded together in a single continuous encasement operation to create a cable of any length.

6. The method of claim 1, wherein two or more flexrail cables are configured to be set inside one another to create higher layered cable densities.

7. The method of claim 1, wherein the self-supporting distances of the flexrail cables are configured to be controlled by adjusting the thickness and width dimensions of the flat piece of steel configured of any metal or non-metallic materials such as plastic.

8. The method of claim 1, wherein the flexrails are configured to be bonded to a cable with any thickness dimension and configured to include one or more conductors, communication and signal cables, fiber optic cables, fluid and gas tubing.

9. The method of claim 1, wherein the width of the cable and bonded flexrails is configured to be controlled by adjusting the thickness dimension of the flat piece of steel and the thickness dimension of the cable.

10. The method of claim 1, wherein the cable motion of the flexrail cable is configured to be parallel wherein the rigid cable sections extending from the flexible bending point maintain a static and dynamic parallelism respectively including a range of horizontal to vertical orientations.

11. The method of claim 1, further comprising a flexrail silicone encasement configured to be any color including clear, white and black and configured to include imprinting a logo onto the outboard side of the flexrail silicone encasement and the silicone encasement is configured to include materials such as silicone, PVC, polyurethane, Teflon and natural rubber.

12. An apparatus, comprising:
means for encasing a flat piece of steel in silicone to form a flexrail; and
means for bonding two or more flexrails to a cable create a flexible self-supporting cable.

13. The apparatus of 12, further comprising means for applying encasement materials such as silicone, PVC, polyurethane, Teflon and natural rubber around a flat piece of steel in a continuous operation to form an encasement of varying lengths.

14. The apparatus in 12 further comprising means for applying a bonding material in a continuous operation to join two or more flexrails and a cable and a means for applying a bonding encasement material in an automatic bonding process to join two or more flat pieces of steel and flat cable elements such as one or more conductors, communication and signal cables, fiber optic cables, fluid and gas tubing to form a joined flexrail cable assembly of any length.

15. The apparatus of 12, further comprising means for controlling the color, shape and dimensions of a silicone encasement around a flat piece of steel.

16. The apparatus of 12, further comprising means for imprinting a logo onto the outboard side of the flexrail silicone encasement.

17. A fabricated cable structure, comprising:
A cable;
a silicone encased flat piece of steel configured to form a flexrail; and
two or more flexrails configured to be bonded to the cable to create a flexrail self supporting cable structure.

18. A fabricated cable structure of claim 17, wherein the bonded flexrails are configured to flex at a bending point and flexrail cable sections extending from the flexible bending point are configured to remain parallel and rigid where unsupported in both a static and dynamic mode of operation including a range of horizontal to vertical orientations.

19. The fabricated cable structure of claim 17, wherein the flexrails are configured to be bonded to a cable with any thickness dimension and including cable elements such as one or more conductors, communication and signal cables, fiber optic cables, fluid and gas tubing and configured to be bonded to the flexrails in a secondary bonding operation and a continuous automated cable fabrication process to form a flexible self-supporting cable.

20. The fabricated cable structure of claim 17, wherein the adjustment of the thickness and width dimensions of the flat piece of steel configured to include materials such as any metal and any non-metallic materials such as plastic and silicone encasement configured to include materials such as silicone, PVC, polyurethane, Teflon and natural rubber is configured to control the self-supporting distances of the flexrail self supporting cable structure in a static or dynamic operation including the range of horizontal to vertical orientations.
